(19) United States
(12) Patent Application Publication
(10) Pub. No.: US 2009/0274591 A1
(43) Pub. Date: Nov. 5, 2009

(54) APPARATUS FOR CATALYTIC THERMOPHYSICAL SCISSION OF LIQUID AMMONIA IN GASEOUS NITROGEN AND HYDROGEN

(76) Inventors: Rosario Rocco Tulino, Montefalcone di Val Fortore (IT); Santino Letizia, Formia (IT); Piero Valentini, Spoleto (IT); Leonardo Valentini, Spoleto (IT)

Correspondence Address: BRINKS HOFER GILSON & LIONE, P.O. BOX 10395, CHICAGO, IL, 60610, US

(21) Appl. No.: 12/296,782

(22) PCT Filed: Apr. 18, 2007
(86) PCT No.: PCT/IT2007/000285

§ 371 Date: Dec. 4, 2008

(30) Foreign Application Priority Data
Apr. 18, 2006 (IT) PG2006A000028

(51) Int. Cl. B01J 19/08

(52) U.S. Cl. 422/186.04; 422/186

(57) ABSTRACT

A compact apparatus for the thermophysical catalytic resolution of liquid ammonia (pressure 10 bar) to produce hydrogen and nitrogen at the gas state. The apparatus uses three reactors placed in cascade, the first two reactors carrying out a thermocatalytic resolution, and the third reactor being a microwave resonator. Hydrogen adapted to supply alkaline fuel cells is obtained after crossing a scrubber. The equipment on board of the vehicles allows the generation of electric energy for car drive with a yield of 12,000 kJ/kg NH₃.

The present invention relates to the energy field and, more specifically, the production of hydrogen by thermophysical resolution of liquid ammonia to be used particularly for supplying alkaline fuel cells. A typical application example of such fuel cells is the production of power for car drive.

The problems connected to the low energy density (energy/volume ratio) of hydrogen with respect to gasoline and gas oil for cars are one of the main obstacles to the spread of such fuel system. Another hindrance to the widespread performance is the inherent safety factor of the installation because of fire and explosion danger especially in case of accident.

The overcoming of these critical aspects enhances the large positive features such as cancelling the polluting emissions as well as high performance and versatility of the energy vector such as hydrogen which can be obtained from a wide variety of primary energy sources even of not fossil origin.

It should be considered that the use of stabilized liquid ammonia in a suitable tank at the pressure of about 10 bars achieves energy densities 10 times as high as the pressure inside a cylinder of compressed hydrogen, more than 50% as high as liquid hydrogen (stored at −253° C. with the relative cryogenic problems), and about double as high as interstitial metal hydrides of alloys of magnesium, lanthanum, pentanickel, etc.

Therefore, it would be greatly desirable to provide compact devices able to carry out the resolution of hydrogen contained in ammonia directly on board of a vehicle to supply alkaline fuel cells which, as known, are able to supply power for car drive at low cost and high energy output.

A primary problem that did not find hitherto a satisfactory solution as far as overall dimension and cost is concerned, thus invalidating any proposal for car drive, is that hydrogen from the resolution of ammonia should be free of carbon compounds in order to supply alkaline fuel cells. Actually, such compounds exert a deactivating action to ion exchange surface of the cell (a typical phenomenon of the acid cells).

To overcome such troubles the inventor of the present invention has set up an apparatus for resolving hydrogen from ammonia in a compact, integral way, which apparatus has two catalytic reactors in cascade to each other followed by a specific microwave resonator performing the dissociation process under the total absence of carbon compounds in the output flow of hydrogen. Then, the flow of gas hydrogen and nitrogen pass through an absorption scrubber able to capture any NH₃ trace before supplying the gases to alkaline fuel cells. The use of alkaline fuel cells which have, as already mentioned, a low manufacturing cost and a high energy output is made feasible by the total absence of carbon compounds (CO₂ present in the reforming).

Trials have shown that such technology produces a work of about 12,000 kJ/kg NH₃ on the shaft of the electric motor associated to the cells, i.e. of the same order of magnitude as the thermal engine presently used for car drive, and with similar results as far as autonomy and consumption is concerned.

Further features and advantages of the present invention will result from the following detailed description with reference to the accompanying drawings that show a preferred embodiment thereof only by way of a not limiting example.

In the drawings:

FIG. 1 is a longitudinal section view of a first catalytic reactor for the first stage of ammonia resolution;

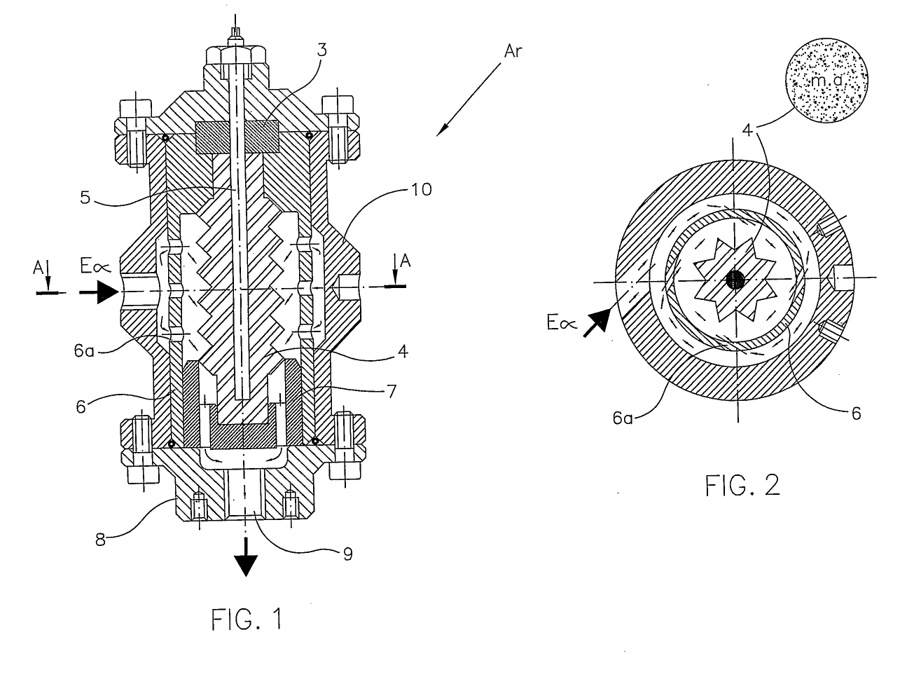

FIG. 2 is a section view of the same reactor along line A-A in FIG. 1;

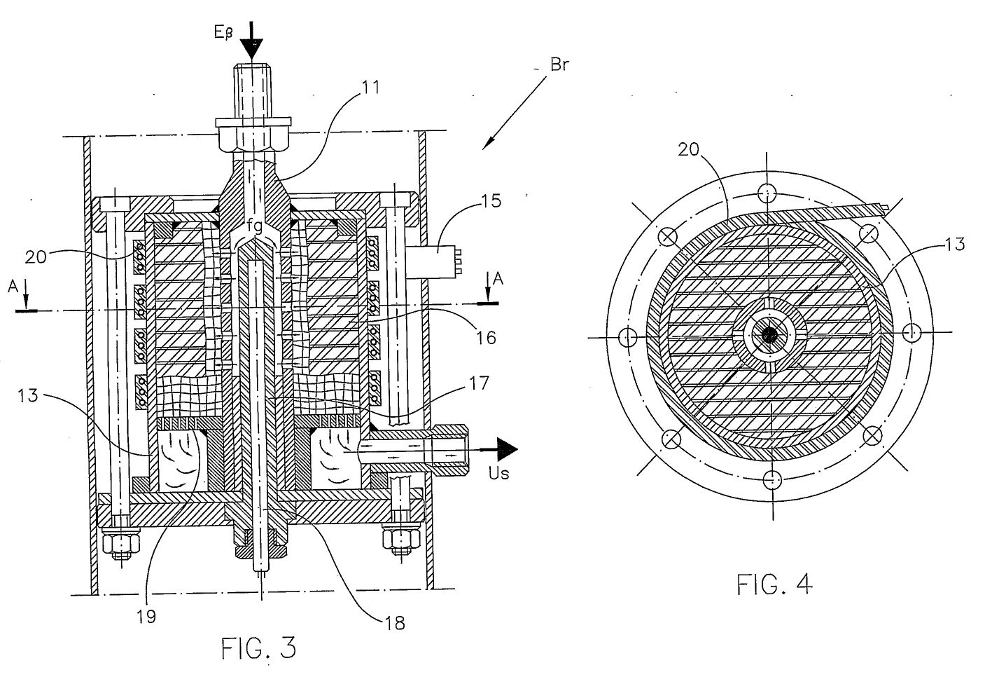

FIG. 3 is a longitudinal section view of the second catalytic reactor for the second stage of resolution;

FIG. 4 is a section view of the same reactor along line A-A in FIG. 3;

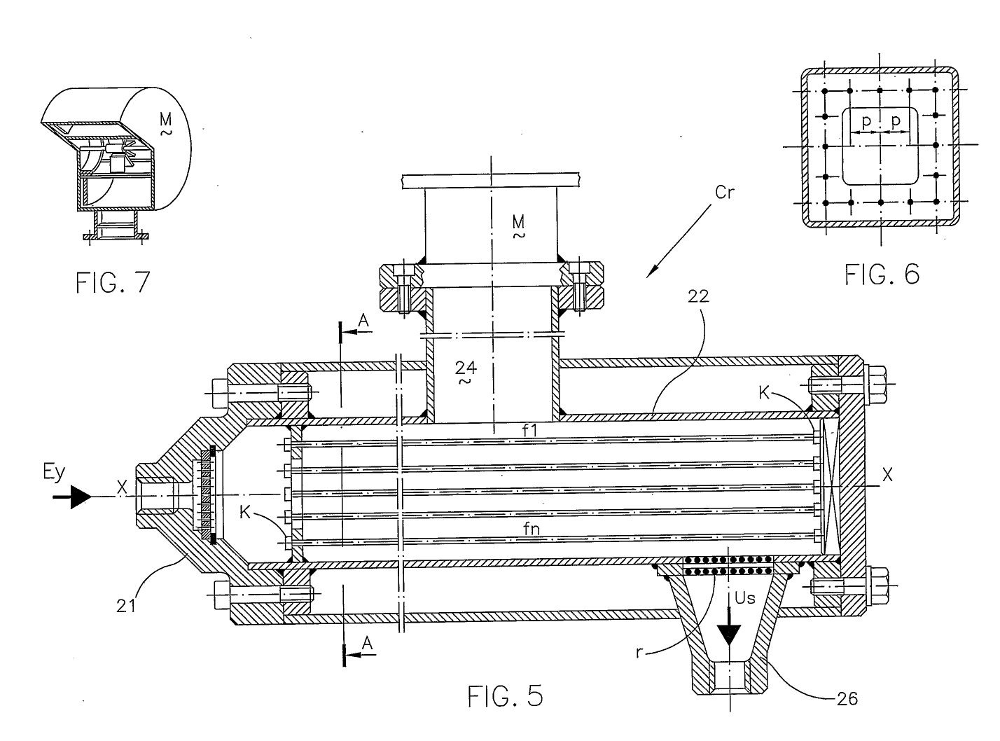

FIG. 5 is a section view of a microwave guide tube forming the third resolution stage to complete the resolution of the residual ammonia;

FIG. 6 is a section view of the waveguide tube of FIG. 5 along line A-A of the same figure;

FIG. 7 shows in reduced scale the microwave emitter device to be bolted crosswise to the waveguide tube;

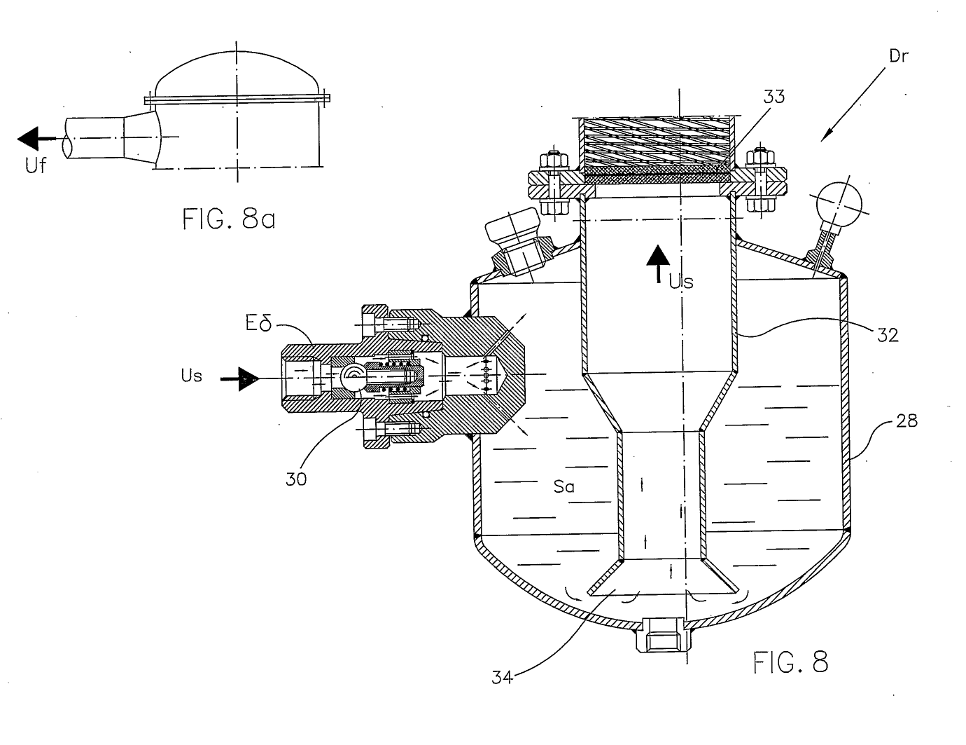

FIGS. 8 and 8a are longitudinal section views of the end scrubber and the dome where output gases are collected.

With reference to the figures the disclosed apparatus is provided with means for executing the resolution reaction of liquid ammonia into its constituents nitrogen and gas hydrogen in three stages in cascade Ar, Br, and Cr. The flow of gas hydrogen and nitrogen from third stage Cr is then passed to an absorption scrubber stage Dr so as to capture any NH₃ trace before said gases are fed to fuel cells.

In particular the first two stages Ar (FIGS. 1 and 2) and Br (FIG. 3 and 4) includes two catalytic reactors which execute a thermocatalytic resolution, while third stage Cr (FIGS. 3, 4, and 5) comprises an electromagnetic resonance duct in the microwave range which terminates the dissociation process.

Now first resolution stage Ar shown in FIG. 1 is taken into consideration. It consists of an outer case 10 of stainless steel which delimitates an inner space with generally cylindrical shape where a tangential-flow diffuser 6 of insulating porcelain, a central body 4 with polygonal cross section and longitudinal bellow section so that a sequence of pyramidal projections with the vertices directed outwards are defined on its mantle, and an armoured electrical resistance 5 which heats said body 4 from the inside, are coaxially placed from the outside to the centre.

According to a peculiar feature of the finding, the material of central body 4 consists of a special sintered alloy, so-called m.a. (mechanical alloying) (50% W-35% Fe-6% Co-5% Ag-4% Mo).

The vaporized ammonia from the specific storage tank crosses duct Ea which opens to outer case 10, and enters tangential-flow diffuser 6 through tangential input holes 6a which create a whirling motion around central body 4 (FIG. 2) . The latter is kept in its position by a ring 3 of insulating porcelain. After the gas flow crosses longitudinally the contact area with bellow body 4 rich in tips and acting as heated catalyser for the resolution of NH₃, it crosses radially the perforated ring 7 of porcelain and flows into the output conduit 9 formed in reactor bottom 8. The output gas products consisting of H₂, N₂ and not dissociated NH₃ enter the second resolving stage Br shown in FIG. 3 through a coupling duct.

The latter reactor with a generally cylindrical shape comprises an outer mantle 13, a central duct 11 connected outside to the coupling duct from the output of first reactor Ar, and a plurality of overlying catalytic ring partitions 16 which are disposed coaxially around said central duct 11 above a perforated diaphragm 19. Central duct 19 is in turn coaxial with a cylinder 17 consisting of the same sintered alloy m.a. used for body 4 of first reactor Ar and is heated from the inside by an armoured resistance 18.

Each catalyser 16 consists of a mix of 30% cobalt oxide and 70% chromium oxide supported on a net of stainless steel.

Mantle 13 of the reactor is heated by electrical band resistances 20, thus establishing a temperature between 500° C. and 750° C. in catalyser partition 16.

Output gases Us of first stage pass through the coupling duct to central duct 11 and reach at the input a temperature Ti in the range of 450° C.-750° C. The gas current indicated at fg flows then to cylinder 17 heated by armoured resistance 18 from the inside. Upon crossing the duct the not dissociated ammonia from first stage Ar is subjected to a further resolution before escaping through a number of holes conveying the gas flow into contact with catalyser 16. The perforated diaphragm 19 conveys output gases Us and connects the output duct of second stage through an insulated duct to input Ey of third stage Cr shown in FIGS. 5 to 7 where the resolution of residual ammonia is terminated.

This third stage consists essentially of a microwave guide tube 22 crossed along the longitudinal axis x-x by the gas flow from Ey, in collector 21 of which a microperforated diaphragm d prevents electromagnetic waves from being conveyed to the outside.

As shown in FIG. 6, wires fᵢ₋ₙ consisting of alloy m.a. are placed at pitch p (a distance which depends on the wavelength λ) in guide tube 22 which has a square section with a width la. These wires fᵢ₋ₙ are heated electrically to a temperature between 550° C. and 750° C. and are insulated from the metal construction by supports K of porcelain (FIG. 5). Wire fᵢ₋ₙ are charged to a high electrostatic potential: under such conditions (strongly polar) molecules of NH₃ are attracted to the wires and ionised. A duct 24 conveying the electromagnetic waves which are emitted by magnetron M operating at the specific frequency ν is positioned transversally to the guide tube. In this way the conditions of stationary motion along longitudinal axis x-x are established: as a result, the electrical component of the electromagnetic waves interacts at the maximum effectiveness (resonance) with the ionised molecules around wires fᵢ₋ₙ, thus resolving their bonds. While the dissociated gases (N₂ +H₂) can be streamed freely through output duct 26, the microwaves are prevented from escaping outside the guide tube by a metal net with crossed meshes r arranged for this purpose (FIG. 5).

A pipe connects flow Us escaping from resonator Cr to scrubber Dr shown in FIG. 8. The latter consists essentially of a closed tank generally indicated at 28 which has an input duct Eδ for flow Us provided with a check valve 30 operating at the pressure “p” (operating pressure of the fuel cells) and a central duct 32 with a lower opening 34 which draws into a solution Sa able to capture even ppm of residual ammonia in the gas flow from the three previous dissociating means. Gases inputted into duct Eδ pass through solution Sa where they release any residual ammonia. Completely dissociated gases (H₂ +N₂) cross central duct 32 at the end of which a partition with defogging net 33 is located, thus conveying to the output a flow Uf of gases H₂ and N₂ which are free from humidity and able to supply fuel cells.

Electric energy with a yield between 60% and 70% can be then generated so that an engine can be operated at a varying number of revolutions and with a greater efficiency than 90%, thus providing a total efficiency of the drive system greater than 55% (about double as high as the thermal engine conversion).

1. An apparatus for the physical-chemical decomposition of liquid ammonia (stored in tanks at liquid status, at pressure of 10-12 bar) into its constituent elements nitrogen and gaseous hydrogen, by the utilization of three devices (Ar, Br, and Cr) placed in cascade and crossed by the flux of gaseous ammonia, of which the first two (Ar, Br) being able to execute a thermocatalytic action and third (Cr) being a microwave resonator.

2. The apparatus according to the preceding claim, characterized in that there is further provided an absorption scrubber (Dr) able to capture any residual NH₃ trace in the gas flow escaping from the microwave resonator before conveying said flow to the user.

3. The apparatus according to claim 1, characterized in that first reactor (Ar) comprises an outer case (10) which delimitates an inner space with generally cylindrical shape where an insulating tangential-flow diffuser (6), a hollow cylindrical central body (4) and an armoured electrical resistance (5) which heats said body (4) from the inside are placed from the outside to the centre.

4. The apparatus according to the preceding claim, characterized in that the insulating diffuser (6) is a whirling diffuser of ceramic material provided with a plurality of tangential inputs (6a) of the dissociating gas flow.

5. The apparatus according to claim 3, characterized in that said hollow central body (4) has a polygonal cross section and a longitudinal bellow section so that a sequence of pyramidal projections with the vertices directed outwards are defined on its mantle which is hit by the dissociating ammonia flow.

6. The apparatus according to claim 1, characterized in that second reactor (Br) comprises an outside mantle (13), a central duct (11) connected outside to the coupling duct from the output of first reactor (Ar), and a plurality of overlying catalytic ring partitions (16) which are coaxially placed around said central duct (11).

7. The apparatus according to the preceding claim, characterized in that the assembly of catalytic ring partitions (16) is hit radially by the gas flow from central duct (11) with axial output and is heated both inside and outside by heating means placed inside central duct (11) and on outside mantle (13) of the reactor.

8. The apparatus according to the preceding claim, characterized in that said means includes: a hollow cylindrical body (17) placed inside central duct (11) and heated from the inside by an armoured resistance (18), and electrical band resistances placed on outside mantle (13).

9. The apparatus according to claim 6, characterized in that each catalytic partition (16) consists of a mix of 15% to 55%, preferably 30%, cobalt oxide CoO, and 45% to 85%, preferably 70%, chromium oxide Cr₂O₃ supported by a net of stainless steel.

10. The apparatus according to claim 1, characterized in that the microwave resonator has a guide tube (22) with a transversal emitter (24) and is crossed longitudinally by the dissociating gas flow.

11. The apparatus according to claim 10, characterized in that wires (fᵢ₋ₙ) heated electrically and insulated from the metal structure by supports (K) of porcelain are placed in guide tube (22).

12. The apparatus according to claim 11, characterized in that said wires (fᵢ₋ₙ) are charged to a high electrostatic potential so that not yet dissociated molecules of NH₃ are attracted to the wires and ionised.

13. The apparatus according to claim 11, characterized in that wires (fᵢ₋ₙ) are placed parallel to the longitudinal axis of guide tube (22) in a number of 4 to 400, preferably 25 to 64, said wires being spaced apart from one another by a pitch (p) depending on the wavelength (λ) of the microwaves.

14. The apparatus according to claims 3, 8 and 11, characterized in that the wires of the resonator and the heating bodies (4, 17) are made of an alloy sintered by thermal catalysis and consisting of 30% to 65%, preferably 50%, tungsten, 15% to 40%, preferably 35%, iron, 3% to 12%, preferably 6%, cobalt, 4% to 10%, preferably 5%, silver, and 2% to 8%, preferably 4%, molybdenum.

15. The apparatus according to claim 14, characterized in that the operation temperature of the sintered alloy used in the three dissociation stages is between 250° C. and 950° C., preferably between 350° C. and 850° C., more preferably between 550° C. and 650° C., and most preferably 600° C.

16. The apparatus according to claim 14, characterized in that the wires of the resonator are insulated from the end plates of the resonator by supports (K) of porcelain.

17. The apparatus according to claim 12, characterized in that the voltage of the electrical field applied to the sheaf of wires (fᵢ₋ₙ) of the resonator is in the range 300 kV to 0.3 kV, preferably 15 kV.

18. The apparatus according to claim 2, characterized in that scrubber (Pr) placed after the thermal dissociation reactors includes a closed tank (28) which has an input duct (Eδ) for the gas flow from reactor (Cr), which duct is provided with a check valve (30) operating at the pressure (p) of the fuel cells, and a central duct (32) with a lower opening (34) which draws into a solution (Sa) able to capture even minimum quantities of residual ammonia in the gas flow from the three previous dissociating means.

19. The apparatus according to the preceding claim, characterized in that the flow gas is inputted perpendicular to the mantle of the tank and the gases defogged by a defogging net (33) are outputted along axial central duct (32).

20. The apparatus according to any preceding claim, characterized in that the operating pressure is in the range 20 bar to 1 bar, preferably 12 bar to 4 bar, more preferably 8 bar.
